(19) United States
(12) Patent Application Publication
(10) Pub. No.: US 2010/0099010 A1
(43) Pub. Date: Apr. 22, 2010

(54) ELECTROCHEMICAL ENERGY SOURCE AND ELECTRONIC DEVICE

(75) Inventors: Rogier Adrianus Henrica Niessen, Eindhoven (NL); Mohammed Meftah, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,417

(22) PCT Filed: Oct. 24, 2007
(86) PCT No.: PCT/IB2007/054321

§ 371 Date: Apr. 6, 2009

(30) Foreign Application Priority Data
Oct. 30, 2006 (EP) 06123125.4

(51) Int. Cl. H01M 4/24; H01M 4/58; H01M 4/56; H01M 4/42; H01M 4/00; H01M 8/16

(52) U.S. Cl. 429/40; 429/209; 429/231.8; 429/218.1; 429/225; 429/229; 429/231.95; 429/220

(57) ABSTRACT

The invention relates to an electrochemical energy source, comprising a substrate, and at least one cell deposited onto said substrate. The invention also relates to an electronic device, said device comprising at least one electrochemical energy source according to invention, and at least one electronic component electrically connected to said electrochemical energy source.

### FIELD OF THE INVENTION

The invention relates to an electrochemical energy source. The invention also relates to an electronic device, said device comprising at least one electrochemical energy source according to invention, and at least one electronic component electrically connected to said electrochemical energy source.

### BACKGROUND OF THE INVENTION

Reserve batteries are nowadays used to provide on-demand power for a wide variety of applications. These batteries each comprises a two electrodes spaced apart, between which electrodes an electrolyte chamber is present for receiving an externally supplied electrolyte. The main advantage of these batteries is their extremely long shelf life as the electrolyte is only added just prior to use. Very promising applications that might be beneficially powered by this type of battery are, among others, disposable small-scale and cheap electronics like biosensors. In these devices a medium, in particular a liquid, to be examined (blood, urine, saliva) can be used as the electrolyte for the reserve battery. However, the performance of a reserve battery is dependent on the surface area of the individual electrodes. In case the known reserve-type battery is incorporated in a small-scale electronic device, the size of the electrodes will be limited by the size of the complete device. Hence, merely small-scaled electrodes can be used for powering the small-scale electronic device, which results in a relatively poor battery performance.

It is an object of the invention to provide a reserve-type electrochemical energy source with an increased performance.

### SUMMARY OF THE INVENTION

This object can be achieved by providing the electrochemical energy source according to the preamble, comprising: a substrate, and at least one cell deposited onto said substrate, the cell comprising: a first electrode, and a second electrode, said first electrode and said second electrode being separated by an electrolyte chamber for receiving an externally supplied electrolyte, wherein at least one electrode is provided with at least one patterned surface. By patterning or structuring one, and preferably both, electrodes of the reserve-type electrochemical energy source according to the invention, a three-dimensional surface area, and hence an increased surface area per footprint of the electrode(s), and an increased contact surface per volume between the at least one electrode and the externally supplied electrolyte is obtained. This increase of the contact surface(s) leads to an improved rate capacity of the energy source, and hence to a increased performance of the energy source according to the invention. In this way the power density in the energy source may be maximized and thus optimized. Due to this increased cell performance a small-scale energy source according to the invention will be adapted for powering a small-scale electronic device in a satisfying manner. Moreover, due to this increased performance, the freedom of choice of (small-scale) electronic components to be powered by the electrochemical energy source according to the invention will be increased substantially. The nature, shape, and dimensioning of the pattern may be various, as will be elucidated below. The externally supplied electrolyte may also be of various nature, wherein for example a substantially liquid-state electrolyte, such as (sea) water, blood, urine, saliva, may be used to activate the energy source according to the invention. However, it is also conceivable to provide the electrolyte chamber with a substantially solid-state electrolyte, a polymer-based electrolyte and/or a gel (gelatinous) electrolyte. The cell of the electrochemical energy source according to the invention is preferably a battery cell. However, in another preferred embodiment, the cell of the electrochemical energy source is a (bio)fuel cell. By implanting a bio fuel cell into a living human or animal body, the bio fuel cell will withdraw readily available bio fuels, such as e.g. glucose from the blood stream, from renewable sources and will convert them into benign by-products with the generation of electricity. Since a bio fuel cell uses concentrated renewable sources of chemical energy, a bio fuel cell commonly has a relatively high energy density and a relatively long lifetime, as a result of which a bio fuel cell can be made relatively small and light, and are hence ideally suitable to be implanted in a living human or animal body. In a particular preferred embodiment, the electrochemical energy source may comprise both a battery cell and a fuel cell, and may hence be considered as a hybrid energy source, in which chemical energy is converted into electrical energy with use of the bio fuel cell, which electrical energy may subsequently be stored in the battery cell to further improve the power output of the energy source according to the invention.

The first electrode preferably comprises an anode, and the second electrode preferably comprises a cathode. It is common that both an anode and a cathode are deposited during depositing of the stack onto the substrate. In case a battery cell is applied, preferably at least one battery electrode of the energy source according to the invention is adapted for storage of active species of at least one of following elements: hydrogen (H), lithium (Li), beryllium (Be), magnesium (Mg), aluminium (Al), copper (Cu), silver (Ag), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of (reserve-type) battery cells, e.g. Li-ion battery cells, NiMH battery cells, et cetera. In a preferred embodiment at least one electrode, more the battery anode, comprises at least one of the following materials: C, Sn, Ge, Pb, Zn, Bi, Sb, Li, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as anode, preferably any other suitable element which is assigned to one of groups 12-16 of the periodic table, provided that the material of the battery electrode is adapted for intercalation and storing of the abovementioned reactive species. The aforementioned materials are in particularly suitable to be applied in lithium ion based battery cells. In case a hydrogen based battery cell is applied, the anode preferably comprises a hydride forming material, such as AB₅-type materials, in particular LaNi₅, and such as magnesium-based alloys, in particular MgₓTi₁₋ₓ.

The cathode for a lithium ion based battery cell preferably comprises at least one metal-oxide based material, e.g. LiCoO₂, LiNiO₂, LiMnO₂ or a combination of these such as. e.g. Li(NiCoMn)O₂. In case of a hydrogen based energy source, the cathode preferably comprises Ni(OH)₂ and/or NiM(OH)₂, wherein M is formed by one or more elements selected from the group of e.g. Cd, Co, or Bi.

In general, the contact surface of the electrode(s) directed to the electrolyte to be supplied may be patterned in various ways, wherein the nature, shape, and dimensioning of the pattern may be arbitrary. Though, it is preferred that at least one surface of at least one electrode is substantially regularly patterned, and more preferably that the applied pattern is provided with one or more cavities, in particular pillars, trenches, slits, or holes, which particular cavities can be applied in a relatively accurate manner. In this manner the increased performance of the electrochemical energy source can also be predetermined in a relatively accurate manner. In this context it is noted that a surface of the substrate onto which the stack is deposited may be either substantially flat or may be patterned (by curving the substrate and/or providing the substrate with trenches, holes and/or pillars) to facilitate generating a three-dimensional oriented battery cell and/or biofuel cell.

Preferably, each electrode comprises a current collector. By means of the current collectors the cell can easily be connected to an electronic device. Preferably, the current collectors are made of at least one of the following materials: Al, Ni, Pt, Au, Ag, Cu, Ta, Ti, TaN, and TiN. Other kinds of current collectors, such as, preferably doped, semiconductor materials such as e.g. Si, GaAs, InP may also be applied to act as current collector.

In a preferred embodiment at least one of the first electrode and the second electrode is covered at least partially by a protective layer. More preferably both electrodes are covered at least partially by a protective layer. The protective layer is adapted to shield the electrode(s) before use to prevent the electrode(s) to be damaged, fouled and/or contaminated or passivated. In a particular preferred embodiment the protective layer is made at least partially of an electrolytic material, which will commonly be relatively efficiently to activate the electrochemical cell upon providing an externally supplied electrolyte to the electrolyte chamber. Since an electrolytic material, such as a particular solid substance, a polymer, or a gel, is used as protective layer, the operation of the cell will commonly not be hindered by the application of the protective layer. In another particular preferred embodiment the protective layer is made at least partially of a dissolvable, in particular a water-soluble material, such as for example a water-soluble (mono)sacharide, such as glucose. By applying a liquid-state electrolyte, in particular a body fluid, the protective layer will be dissolved in the electrolyte, after which the electrochemical cell will commonly be activated.

The electrochemical energy source preferably comprises at least one barrier layer being deposited between the substrate and at least one electrode, which barrier layer is adapted to at least substantially preclude diffusion of active species of the cell into said substrate. In this manner the substrate and the electrochemical cell will be separated chemically, as a result of which the performance of the electrochemical cell can be maintained relatively long-lastingly.

In a preferred embodiment, both the first electrode and the second electrode are deposited directly onto the substrate. Direct depositing of the electrodes onto the substrate facilitates manufacturing of the electrochemical energy source according to the invention. The space between both electrodes defines the electrolyte chamber. Stacking both electrodes on top of each other, wherein an open space is left between both electrodes, is relatively laborious to generate, and hence less preferable.

In a preferred embodiment preferably a substrate is applied, which is ideally suitable to be subjected to a surface treatment to pattern the substrate, which may facilitate patterning of the electrode(s). The substrate is more preferably made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. It may be clear that also other suitable materials may be used as a substrate material.

The electrochemical energy source is preferably adapted for bioimplantation to monitor or to stimulate certain biological processes in a living or eventually deceased body. The electrochemical energy source according to the invention may be used e.g. for powering bioimplantable microdevices, such as MicroElectroMechanical Systems (MEMS), and implantable biomedical devices such as cardiac pacemakers, sensors, defibrilators, pain relief stimulators, microscopic wireless communication equipment, et cetera. Therefore, it is preferred to apply a liquid-state electrolyte, and more preferably a body fluid. In an alternative preferred embodiment, the electrochemical energy source is adapted to be used ex-vivo, id est outside a living human of animal body. In this latter embodiment, the energy source is preferably used as sensing device for e.g. sensing the presence and/or the concentration of specific species in an electrolyte, in particular a body fluid taken from a living body.

The invention also relates to an electronic device provided with at least one electrochemical energy source according to the invention, and at least one electronic component connected to said electrochemical energy source. The miniaturized electronic device may be formed e.g. by MicroElectroMechanical Systems (MEMS), cardiac pacemakers, sensors, defibrilators, pain relief stimulators, and microscopic communication equipment. It will be clear that this enumaration may not be considered as being limitative. The at least one electronic component is preferably at least partially embedded in the substrate of the electrochemical energy source. In this manner a System in Package (Sip) may be realized. In a SiP one or multiple electronic components and/or devices, such as integrated circuits (ICs), actuators, sensors, receivers, transmitters, et cetera, are embedded at least partially in the substrate of the electrochemical energy source according to the invention. The at least one electronic component is preferably chosen from the group consisting of: sensing means, pain relief stimulating means, (wireless) communication means, and actuating means. It is also possible to add one or more capacitors too boost power output when needed. The electronic device may be adapted either for in-vivo purposes and/or for ex-vivo purposes.

### BRIEF DESCRIPTION OF THE DRAWINGS

The invention is illustrated by way of the following non-limitative examples, wherein:

FIG. 1 shows a schematic cross section of a conventional reserve-type energy source,

FIG. 2 shows a schematic cross section of an electronic device according to the invention,

FIG. 3 shows a schematic cross section of a detail for the electronic device according to FIG. 2, and

FIG. 4 shows a perspective view of another electronic device according to the invention.

### DETAILED DESCRIPTION OF THE EMBODIMENTS

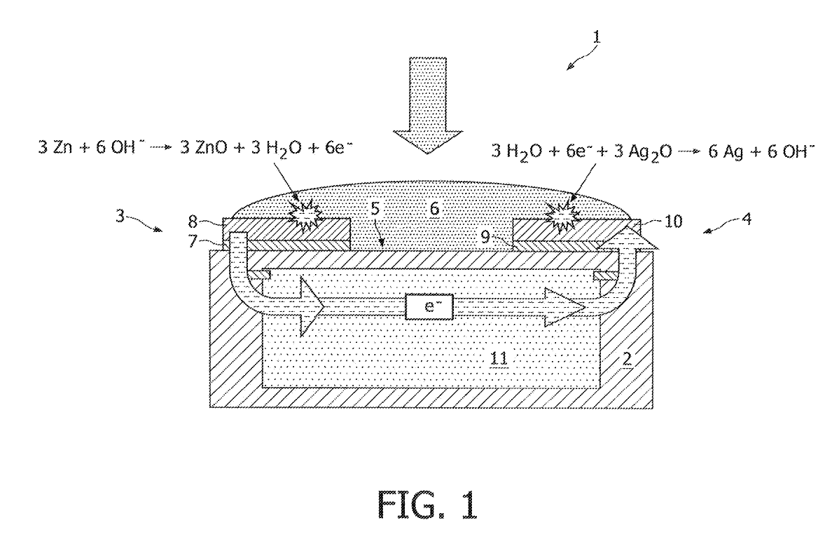

FIG. 1 shows a schematic cross section of a conventional reserve-type energy source 1. The energy source 1 comprises a substrate 2 onto which a planar negative electrode 3 and a planar positive electrode 4 are deposited. Between both planar electrodes 3, 4 an electrolyte chamber 5 is provided which is filled with a liquid electrolyte 6, such as saliva, in this example of the prior art. The first electrode 3 comprises a (first) current collector 7, and an anode 8 deposited on top of the current collector 7. The second electrode 4 comprises a (second) current collector 9, and a cathode 10 deposited on top of the current collector 9. In this example, the anode 8 is made of zinc, while the cathode 10 is made of silver oxide. By providing the electrolyte chamber 5 with electrolyte 6 an electrochemical reaction will be initiated both at the anode 8 and at the cathode 10 as shown. The electrical energy generated by the energy source 1 is used for powering an electronic device 11 incorporated within the substrate 2. A major drawback of this known energy source 1 is that the performance of the energy source 1 is relatively poor, as a result of which the freedom in the electronic device to be applied will be restricted considerably.

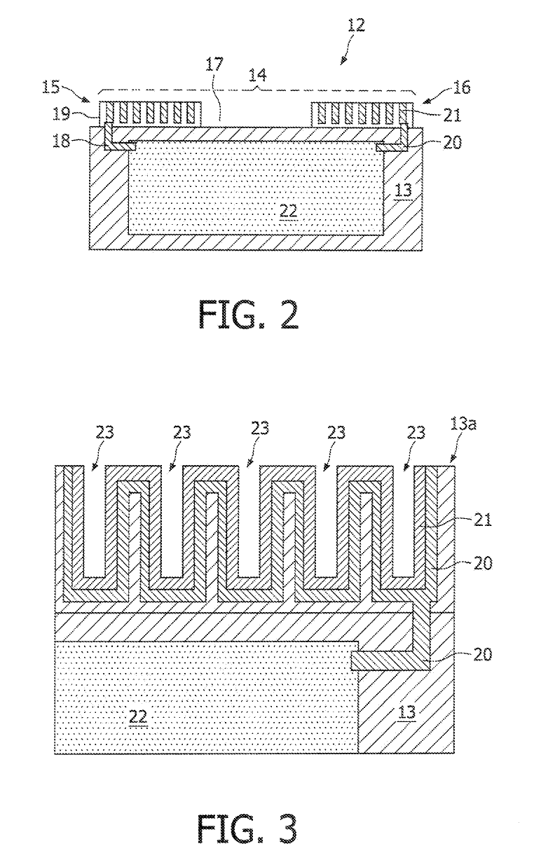

FIG. 2 shows a schematic cross section of an electronic device 12 according to the invention. The electronic device 12 may be bioimplantable or may be suitable for use outside a human or animal body, and comprises a substrate 13 onto which an electrochemical cell 14 is deposited. The cell 14 may be either a battery cell or a fuel cell. The cell 14 comprises a patterned first electrode 15 and a patterned second electrode 16. Between both three-dimensionally oriented electrodes 15, 16 an electrolyte chamber 17 is provided, which will be filled at least partially with an electrolyte (not shown), such as blood, saliva, water, during operation of the electronic device 12. The first electrode 15 comprises a (first) current collector 18, and an anode 19 deposited on top of the current collector 18. The second electrode 16 comprises a (second) current collector 20, and a cathode 21 deposited on top of the current collector 20. The anode 19 and the cathode 21 of the cell 14 together form a couple. In case a battery cell 14 is applied, the battery cell 14 preferably comprises one of the following couples of an anode 19 and an cathode 21 respectively: Zn—AgO, Al—H₂O₂, Al—NaOCl, Al—AgO, Mg—H₂O₂, Mg—NaOCl, Mg—AgCl, Mg—CuCl. Each couple will have its own cell potential and energy and charge density. It will be clear that also other couples may be used in the electronic device 12 according to the invention. Alternatively, the cell 14 is formed by a (bio)fuel cell which may represent an oxyglucose cell, which could rely upon an electrochemical process in which glucose is oxidized at the cathode 21 and molecular oxygen is reduced at the fuel cell anode 19 during operation. The electrical energy generated by the cell 14 will be used for powering an electronic component 22 embedded in the substrate 13. In this embodiment both current collectors 18, 20 are in fact formed by electrical leads 18, 20, by means of which leads 18, 20 the cell 14 is electrically coupled to the electronic component 22. Since the cell 14 comprises patterned electrodes 15, 16, and in particular a patterned anode 19 and cathode 21 respectively, the contact surface area between both electrodes 15, 16 on one side and the electrolyte on the other side can be increased significantly, as a result of which the capacity of the cell 14 can also be increased significantly which will be in favour of the freedom of design of the electronic device 12 according to the invention, and in particular of the electronic component 22 incorporated within the substrate 13.

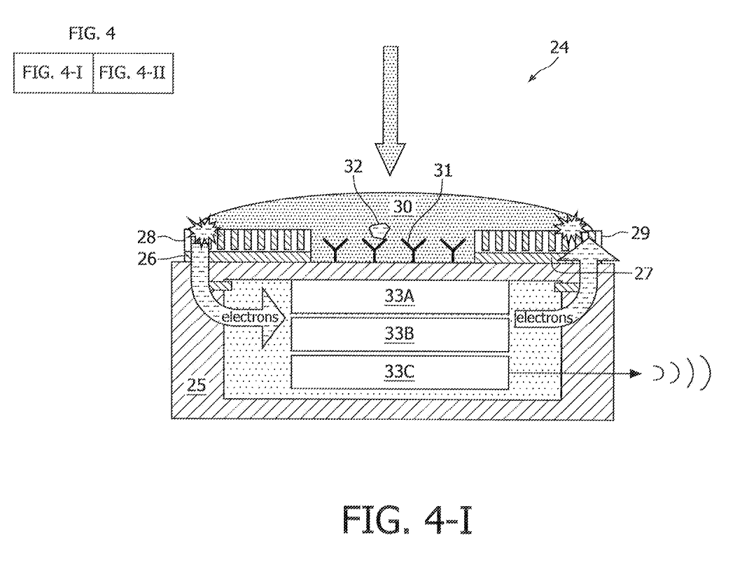

FIG. 3 shows a schematic cross section of a detail of the electronic device 12 according to FIG. 2. In this figure it is clearly shown that an upper surface 13a of the substrate 13 is partially provided with cavities 23. The positive electrode 16 is deposited on the patterned upper surface 13a of the substrate 13, wherein a part of the positive electrode 16 is also deposited within the cavities 23, as a result of which the electrode 16 will also be patterned in a brush-like manner which will lead to an increase of the contact surface area between the electrode 16 and an electrolyte, and hence to an increase of the capacity of the electrochemical cell 14. The negative electrode 15 will commonly be shaped in a similar manner. The electronic device 12 may be disposable and hence be adapted for single-use. However, it is also conceivable that the electronic device 12 will be used multiple times. In this latter case, the width and the depth of the cavities 23 are preferably sufficiently large to enable cleaning (rinsing) of the cavities 23 to counteract fouling of the cavities 23 by the electrolyte. Hence, the optimum size of the cavities 23 will commonly depend on the electrolyte to be provided to the electrochemical cell 14.

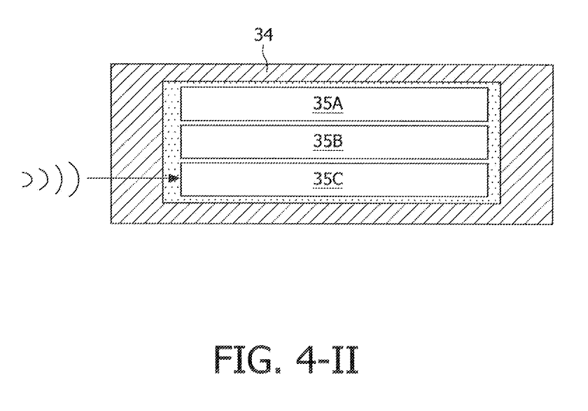

FIG. 4 shows a perspective view of another electronic device 24 according to the invention. The electronic device 24 according to FIG. 4 is a bioimplantable electronic device 24 adapted to be implanted in a living (or deceased) body. The electronic device 24 comprises a substrate 25 on top of which two separate current collectors 26, 27 are deposited, on top of which current collectors 26, 27 an anode 28 and a cathode 29 are deposited respectively. An electrolyte 30 may be brought into contact with both the anode 28 and the cathode 29 to initiate an electrochemical reaction within said electronic device 24. Between the cathode 28 and the anode 29 a biorecognition layer 31 may be provided on top of the substrate 25, wherein the biorecognition layer 31 is adapted to selectively recognize biological species 32, such as specific antigenes, being present in the electrolyte 30. It is noted that the biorecognition layer may also be positioned at another surface area of the substrate, not being between the anode 28 and the cathode 29, to prevent an eventual disturbance of the sensing process due to the electrical field present between the anode 28 and the cathode 29 during electrochemical activity of the electronic device 24.

Multiple electronic components 33a, 33b, 33c are incorporated within the substrate 25 to process the analytic information detected by the biorecognition layer 31 and to wirelessly transmit this information to an external receiving station 34. This receiving station 34 may be a particular computer provided with multiple electronics 35a, 35b, 35c to store, to process, and/or to (real-time) visualise this analytic information.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source, comprising:
a substrate, and
at least one cell deposited onto said substrate, the cell comprising:
a first electrode, and
a second electrode,
said first electrode and said second electrode being separated by an electrolyte chamber for receiving an externally supplied electrolyte,
wherein at least one electrode is provided with at least one patterned surface.

2. Electrochemical energy source according to claim 1, characterized in that both the anode and the cathode are provided with at least one patterned surface.

3. Electrochemical energy source according to claim 1, characterized, in that the first electrode comprises an anode, and/or that the second electrode comprises a cathode.

4. Electrochemical energy source according to claim 3, characterized in that both the anode and the cathode are adapted for storage of active species of at least one of following elements: H, Li, Be, Mg, Cu, Ag, Na and K.

5. Electrochemical energy source according to claim 3, characterized in that at least one of the battery anode and the battery cathode is made of at least one of the following materials: C, Sn, Ge, Pb, Zn, Bi, Li, Sb, and, preferably doped, Si.

6. Electrochemical energy source according to claim 1, characterized in that the at least one patterned surface of the at least one electrode is provided with multiple cavities.

7. Electrochemical energy source according to claim 6, characterized in that at least a part of the cavities form pillars, trenches, slits, or holes.

8. Electrochemical energy source according to claim 1, characterized in that the cell is formed by a battery cell.

9. Electrochemical energy source according to claim 1, characterized in that the cell is formed by a biofuel cell.

10. Electrochemical energy source according to claim 1, characterized in that the first electrode and the second electrode each comprises a current collector.

11. Electrochemical energy source according to one claim 10, characterized in that the at least one current collector is made of at least one of the following materials: Al, Ni, Pt, Au, Ag, Cu, Ta, Ti, TaN, and TiN.

12. Electrochemical energy source according to claim 1, characterized in that both the first electrode and the second electrode are deposited directly onto the substrate.

13. Electrochemical energy source according to claim 1, characterized in that at least one of the first electrode and the second electrode is covered at least partially by a protective layer.

14. Electrochemical energy source according to claim 13, characterized in that the protective layer is made at least partially of an electrolytic material.

15. Electrochemical energy source according to claim 13, characterized in that the protective layer is made at least partially of a dissolvable material.

16. Electrochemical energy source according to claim 1, characterized in that the energy source further comprises at least one electron-conductive barrier layer being deposited between the substrate and at least one electrode, which barrier layer is adapted to at least substantially preclude diffusion of active species of the cell into said substrate.

17. Electrochemical energy source according to claim 16, characterized in that the at least one barrier layer is made of at least one of the following materials: Ta, TaN, Ti, and TiN.

18. Electrochemical energy source according to claim 1, characterized in that the substrate comprises Si and/or Ge.

19. Electrochemical energy source according to claim 1, characterized in that the electrochemical energy source is adapted for bioimplantation.

20. Electronic device suitable for bioimplantation, comprising at least one electrochemical energy source according to claim 1, and at least electronic component connected to said electrochemical energy source.

21. Electronic device according to claim 20, characterized in that the at least one electronic component is at least partially embedded in the substrate of the electrochemical energy source.

22. Electronic device according to claim 20, characterized in that the electronic device is adapted for bioimplantation.

23. Electronic device according to claim 20, characterized in that the electronic device is adapted for ex-vivo use.

24. Electronic device according to claim 20, characterized in that the at least one electronic component is chosen from the group consisting of: sensing means, pain relief stimulating means, communication means, and actuating means.

25. Electronic device according to claim 20, characterized in that the electronic device and the electrochemical energy source form a System in Package (SiP).
